(19) United States
(12) Patent Application Publication
(10) Pub. No.: US 2008/0283659 A1
(43) Pub. Date: Nov. 20, 2008

(54) Buoyancy launch vehicle

(76) Inventor: Jared Scott Hornbaker, Hays, KS (US)

Correspondence Address: Jared S. Hornbaker, P.O. Box 23, Lewis, KS, 67552, US

(21) Appl. No.: 11/724,570

(22) Filed: May 16, 2007

(51) Int. Cl. B64C 39/02

(52) U.S. Cl. 244/2

(57) ABSTRACT

A launching vehicle that is lighter than air and capable of lifting a space bound payload to the upper atmosphere, reducing the energy required for spaceflight. Several possible configurations include but are not limited to. First, a single conventional balloon comparable to a large weather balloon for small payload or low orbit launches. Second, a layered configuration of several balloons stacked one on top of another increasing payload capacity. Third, a grouped configuration utilizing a structure lifted with the payload to accommodate more balloons and provide a stable structure from which to launch. Fourth a ring or doughnut shaped balloon could be used to carry the payload allowing fully vertical launch. Fifth, the ring shaped balloons could be stacked vertically and or grouped concentrically to allow for large payloads. Sixth, one or more umbilical attachments could be attached to the spacecraft allowing it to siphon the lifting gas for fuel when optimal balloon altitude assuming a fuel capable gas is utilized in the balloon.

### BACKGROUND OF THE INVENTION

### 1. Field of the Invention

The invention pertains to the launching of payloads into orbit and beyond.

### SUMMARY OF THE INVENTION

The present application is meant as an inexpensive alternative to multiple stage launch rockets. The application is for the use of a lighter than air vehicle to move a payload to the upper atmosphere allowing a reduction in the size of the rocket engine and or amount of fuel required to launch a given payload. A single rocket engine can cost many millions of dollars, while a high altitude balloon is relatively inexpensive. This vehicle is not an alternative to using rockets only a measure to reduce the number needed and thereby lower the cost per launch. While the balloon is incapable of lifting the payload completely above the atmosphere; it can move it to between 100,000 and 170,000 feet. This reduces the actual distance the payload must travel and thereby it reduces the energy required for the launch. Secondly moving the payload to the outer edge of the atmosphere before launching it reduces the amount of drag it will experience since it will not be forced to push though the denser portion of the atmosphere. The possible configurations of this application are numerous and those listed are meant to exhibit possibilities both for small and large payload launches.

### BRIEF DESCRIPTION OF THE DRAWINGS

The following configurations were chosen to demonstrate several ways that could be utilized to move both large and small payloads:

FIG. 1 is the basic design as viewed from the side

FIG. 2 is an expanded version of the FIG. 1 design allowing for a larger payload as viewed from the side.

FIG. 3A is the structure and lifting balloons as viewed from the side.

FIG. 3B is the structure and lifting balloons as viewed from above.

FIG. 3C is the structure and lifting balloons as viewed form the bottom.

FIG. 4A is the ring shaped lifting balloon as viewed from the side.

FIG. 4B is the ring shaped lifting balloon as viewed from above.

FIG. 5A is the layered version of the ring shaped lifting balloon as viewed from the side.

FIG. 5B is the layered version of the ring shaped lifting balloon as viewed from above.

FIG. 5C is the concentric version of the ring shaped lifting balloon as viewed from the side.

FIG. 5D is the concentric version of the ring shaped lifting balloon as viewed from above.

FIG. 5E is the layered concentric ring version of the ring shaped lifting balloon as viewed from the side.

FIG. 5F is the layered concentric ring version of the ring shaped lifting balloon as viewed from above.

FIG. 6A is the version of the concentric ring design using umbilical attachments to allow the lifting gas to be used for initial fuel as viewed from the side.

FIG. 6B is the version of the concentric ring design using umbilical attachments to allow the lifting gas to be used for initial fuel as viewed from above.

### DETAILED DESCRIPTION OF THE DRAWINGS

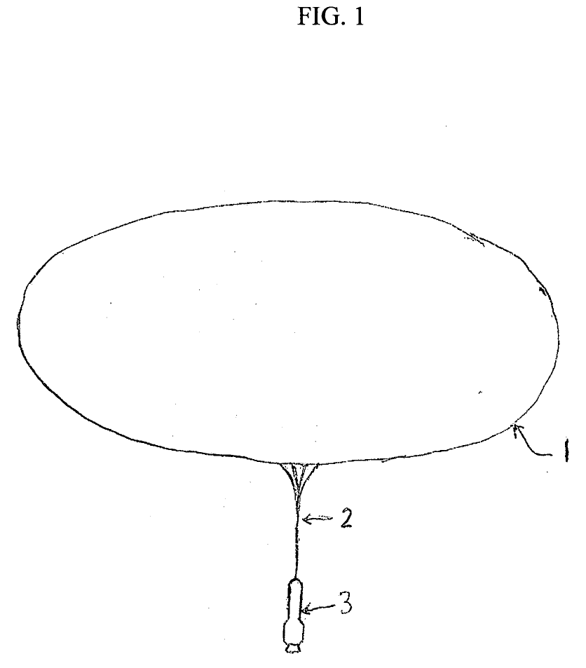

In FIG. 1 the basic balloon 1 is connected to the payload 3 by connecting cables 2.

In FIG. 2 the basic balloons 4 are tethered together by connecting cables 6 to a central cable 5 that is connected to the payload 7.

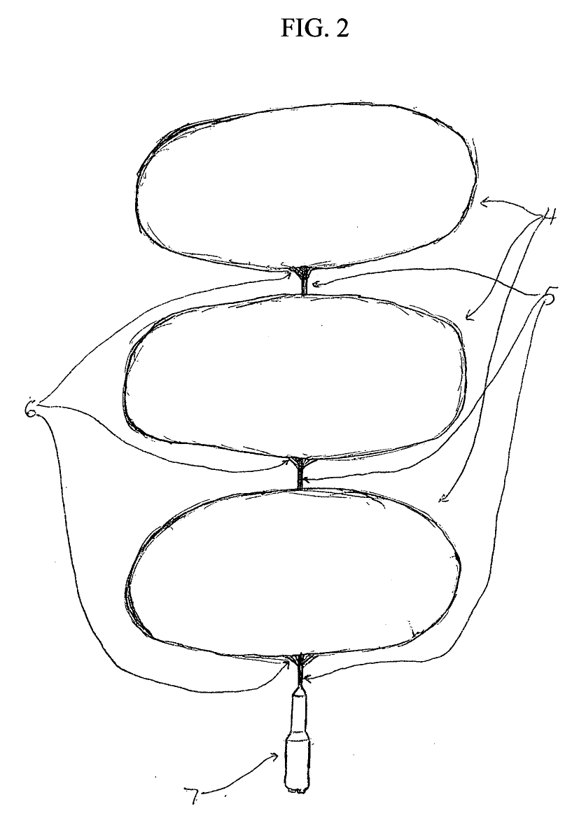

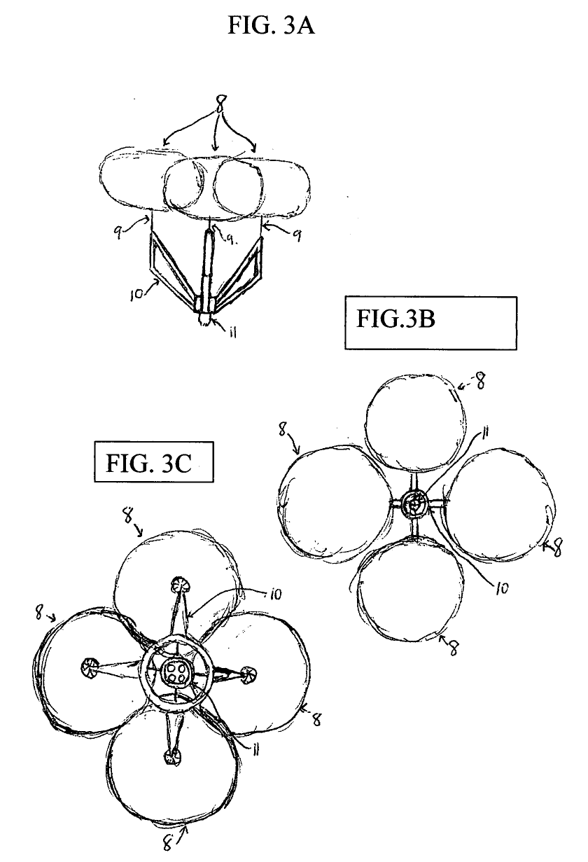

In FIG. 3A,B,C the grouped basic balloons 8 are connected by connecting cables 9 to the launch structure 10 which is providing a platform from which the payload can launch vertically.

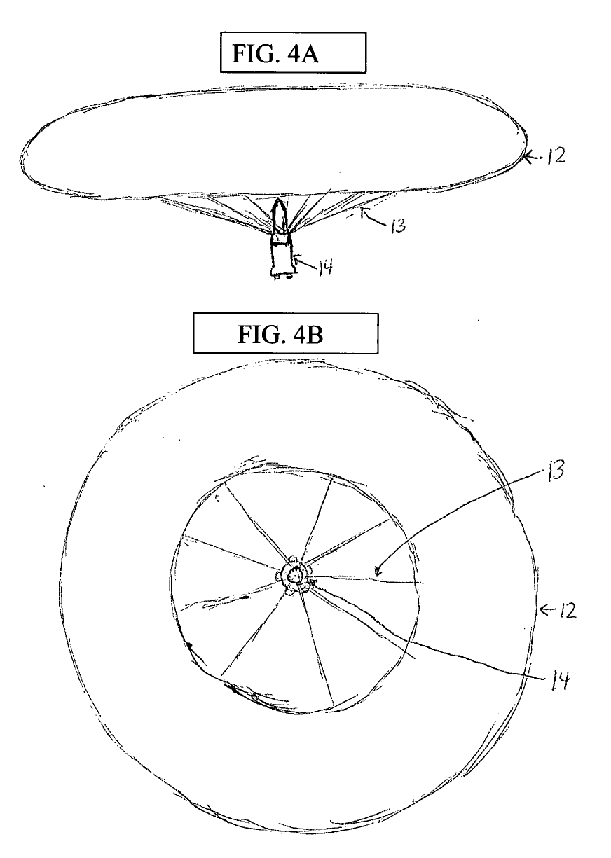

In FIG. 4A,B the ring shaped balloon 12 is connected by connecting cables 13 to the payload 14.

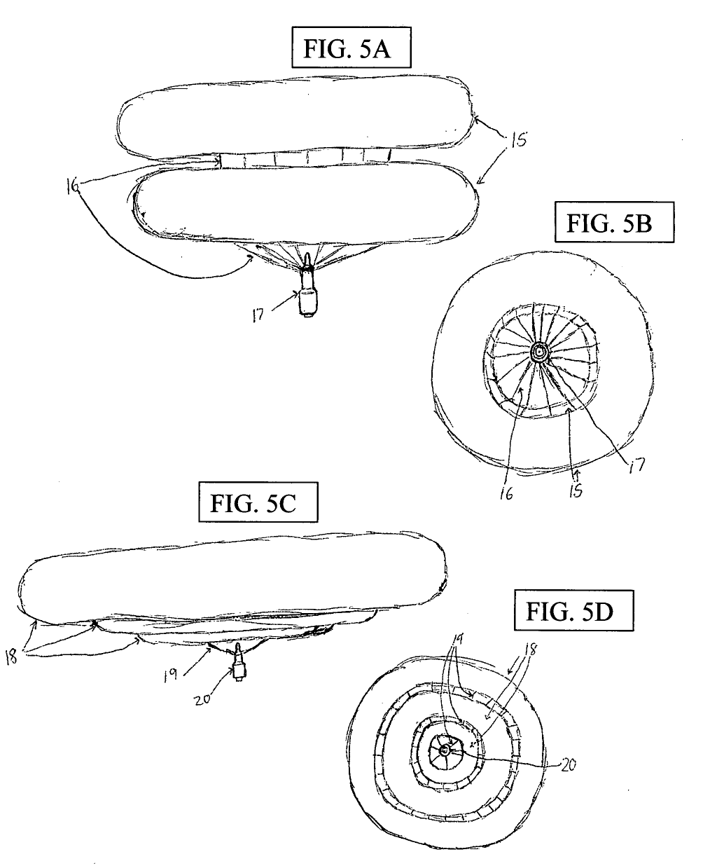

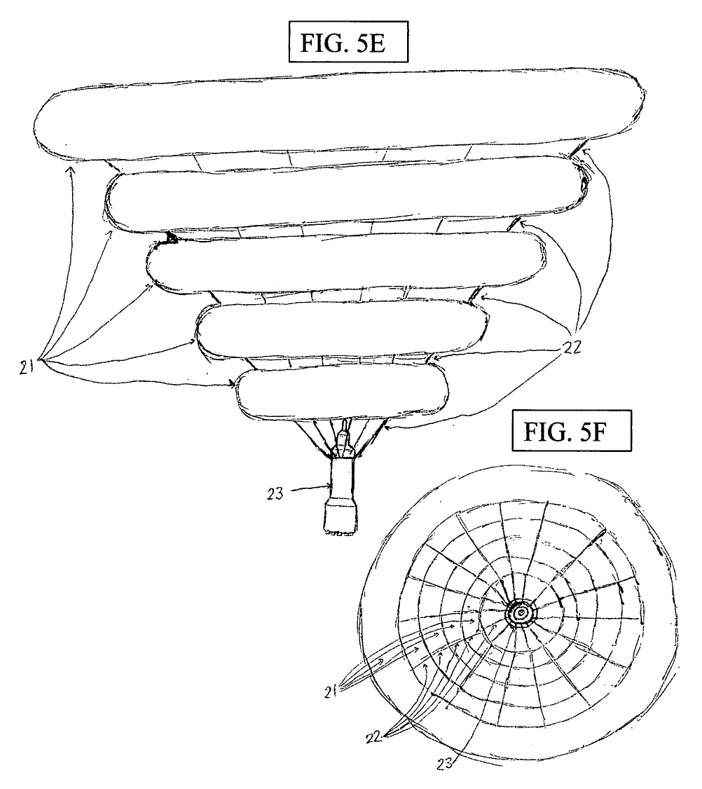

In FIG. 5A,B the stacked ring shaped balloons 15 are connected to each other and the payload 17 by connecting cables 16.

In FIG. 5C,D the concentric ring balloons 18 are connected to each other and the payload 20 by connecting cables 19.

In FIG. 5E,F the layered concentric ring balloons 21 are connected to each other and the payload 23 by connecting cables 22 located in the center of the rings.

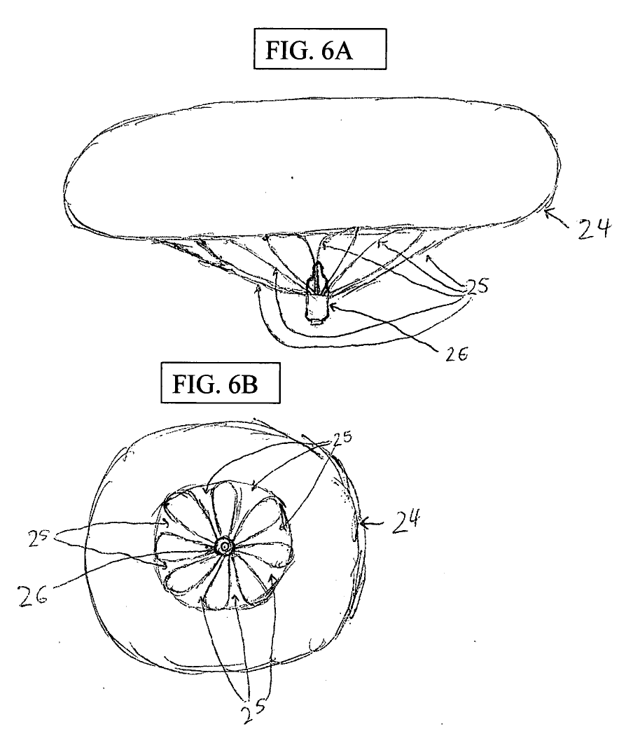

In FIG. 6A,B the ring shaped balloon 24 is connected to the payload 26 by umbilical attachments 25 allowing the rocket to siphon gas from the balloon as propellant.

1: The use of a lighter than air vehicle, (balloon or dirigible) to carry a space bound payload to the upper atmosphere before rocket ignition as shown in FIG. 1.
Dependent claim 1: The use of more than one vehicle described in claim 1 stacked vertically as represented in FIG. 2, allowing a larger payload.
Dependent claim 2: The use of multiple vehicles as described in claim 1 grouped together around a structure lifting the payload as shown in FIG. 3A,B,C.
Dependent claim 3: The use of a vehicle as described in claim 1, but ring shaped allowing the launch of the payload through the center as shown in FIG. 4A,B.
Dependent claim 4: The use of several of the ring shaped vehicles described in Dependent claim 3, stacked vertically as shown in FIG. 5A,B.
Dependent claim 5: The use of several of the ring shaped vehicles described in Dependent claim 3, grouped concentrically as shown in FIG. 5C,D.
Dependent claim 6: The use of several of the ring shaped vehicles described in Dependent claim 3, stacked vertically and grouped concentrically as shown in FIG. 5E,F.
Dependent claim 7: The use of a vehicle as described in Dependent claim 3, with umbilical attachments allowing the siphoning of lift gases to be used for propellant once optimal launch altitude is achieved as shown in FIG. 6A,B.
